(19) United States
(12) Patent Application Publication
(10) Pub. No.: US 2013/0316723 A1
(43) Pub. Date: Nov. 28, 2013

(54) SYSTEM FOR FACILITATING PARTICIPATION OF A PLURALITY OF PILGRIMS IN AN ANNUAL PILGRIMAGE

(71) Applicants: Sami Saleh ALWAKEEL, Riyadh (SA); Mohammed Mahmoud ALWAKEEL, Tabuk (SA); Bassem ALHALABI, Boca Raton, FL (US)

(72) Inventors: Sami Saleh ALWAKEEL, Riyadh (SA); Mohammed Mahmoud ALWAKEEL, Tabuk (SA); Bassem ALHALABI, Boca Raton, FL (US)

(21) Appl. No.: 13/478,496

(22) Filed: May 23, 2012

(51) Int. Cl. H04W 4/02

(52) U.S. Cl. 455/456.1

(57) ABSTRACT

A system used to facilitate participation of a plurality of pilgrims in a seasonal pilgrimage throughout predetermined locations in Saudi Arabia to the extent of providing assistance, advertisement and educational information used by all pilgrims who perform the annual pilgrimage (Hajj) ritual in Saudi Arabia. The cities of Mecca and Medina are visited by millions of pilgrims (Hajjis) over a seasonal period of two weeks. Utilizing a plurality of mobile, wireless, interactive communication devices distributed to and operated by the plurality of pilgrims, as well as government/public authority and a plurality of pilgrim guides, the system facilitates transporting, processing, supporting and educating the vast number of pilgrims from various countries throughout the world including their arrival, departure and guidance throughout the locations where the pilgrimage is to be conducted.

### BACKGROUND OF THE INVENTION

1. Field of the Invention

This invention is directed to a system to facilitate the participation of a plurality of pilgrims (Hajjis) who perform the annual pilgrimage ritual (Hajj) in Saudi Arabia. The system comprises the aiding, processing, educating, informing and protecting millions of pilgrims prior to, throughout and after the pilgrimage season and in doing so relies on interactive, wireless communication devices distributed to and operated by the plurality of pilgrims (H) a plurality of pilgrim guides (G) and a plurality of Concerned Government Authorities, or for simplicity, Police or Public Authority (P).

2. Description of the Related Art

People from all over the world perform the Hajj ritual at least once in their lifetime. This amounts to approximately five million visitors every year to the cities of Mecca and Medina in Saudi Arabia. The annual Hajj ritual is performed on an exact, specific number of days on the lunar calendar from month of Thaul-Hijja, 1 through 15 of each lunar year. In the year 2012, the first day of the month Thaul-Hijja of the lunar year 1433H aligned with Oct. 17, 2012.

All Hajjis (Hajj observers or pilgrims) must be commonly located as they all move from one site to another through the few days of the pilgrimage season. Hajjis normally travel in groups with a group guide (G), who is in charge of his group and their movement throughout the whole pilgrimage participation. The groups are hosted and handled locally by hosting agencies called Mutawif Establishments (MUT). The MUT's are approved or appointed by the Ministry of pilgrimage (Hajj) (MOH). In such a massive gathering where people are concentrated in groups, the chance is very high that many individuals divert from their groups and become lost among other groups or throughout the various locations. If the lost individual panics and tries to contact the public or other government agencies using conventional means of communication, the result will be an overwhelming situation. As a result it will be difficult or near impossible to locate each misplaced or missing individual and help them reconnect with their intended or proper group or hosting agency.

Another major concern is the arrival the millions of people within a relative few days into Saudi Arabia. Such concentrated arrival has been a constant challenge in the airports and other ports of entry locations. By way of example, airplanes arrive by the minute carrying hundreds of people who must be processed, effectively, efficiently and quickly.

Moreover, there is a need not only to provide safety and guidance to the millions of pilgrims but also to provide useful information and educational materials to alert the pilgrims what to perform for each ritual, based on the time of day and physical location throughout the various sites and cities, and throughout the pilgrimage season.

Accordingly, there is a need for a system which facilitates participation of an extremely large number of pilgrims, throughout the relative few days of seasonal pilgrimage of the type referred to hereinafter. A preferred and proposed system should be capable to handle the pilgrims arrivals, facilitate their data processing, provide educational, instructional and advertisement materials and otherwise facilitate their participation and eventual departure. Effective participation in the pilgrimage also includes each of the pilgrims (H) entire data profile being entered in an online master database system as well as onto personal, mobile, handheld, wireless communication devices distributed to and operated by each pilgrim.

In addition, prior to the arrival each Hajji (H), well knows in advance which port of entry for Saudi Arabia he is assigned to. Each pilgrim (H) will also know in a preferred and proposed system which hosting agency will meet him at the port of entry, guide him to his location, inform and educate him as to food as well as many other services. All of this at least preliminary processing can be accomplished by using modern day scanning techniques directly associated with the scanning capabilities of each of the mobile communication units assigned to pilgrims.

In short, the proposed system of the present invention will provide numerous benefits to the official governmental authorities as well as to the millions of pilgrims covering their safety, guidance, data processing and educational needs throughout the pilgrimage season.

Further facilities associated with the proposed system relate to advertisement capabilities where the pilgrim can find information about products, gifts and other merchandise and services available at various locations throughout the pilgrimage sites during the entire pilgrimage season.

### SUMMARY OF THE INVENTION

Total Hajj season and its operation and the handling of millions of people comprises probably largest single annual human gathering in the world. The government of Saudi Arabia is in constant preparation for this annual season.

As such certain basic steps are realized in order to facilitate participation in the pilgrimage and the entire operation, including arrival and departure of the pilgrims before and after the pilgrimage season. The Ministry of Hajj (MOH) maintains its own secured Ministry database (MDB) of all pilgrims (Hajjis), (H), in the world. This database is progressively updated as Mutawif Establishments (MUT) keep feeding data into and throughout the Hajj season. Hajji data is supervised by Mutawif Establishments (MUT) located in Saudi Arabia and stored in a central database and web server (CDW) secured within the Ministry of HAJJ in Saudi Arabia. The data is collected from travel agencies (TA) which are approved by (MUT) and contracted by individual Hajjis as they plan to travel. Foreign State official Missions, which are appointed by their respective governments outside the Kingdom of Saudi Arabia to process Hajj affairs for their citizens, are thought of as the travel agencies (TA).

Hajji information management and data is handled by the corresponding IT companies called centers of Omra and Hajji Services (COS), which are licensed by the Ministry of HAJJ (MOH). The MOH processes data and approves visas through Ministry of Foreign Policy and Ministry of Interior National Information Center. The National Information Center will validate the data and add a unique (border's number) for each Hajji and return it to MOH. A copy of Hajji data will be available to these three ministries. Visas are issued to hajji from Saudi consulates throughout the world based on the information received from Hajj Ministry. When a pilgrim (Hajji), (H) arrives into the Kingdom, he meets a representative of the MUT (called General Agent Office) who will process his documents and hand him over to an assigned MUT. The MUT will take care of all Hajji tasks and coordinate all activities with the (MOH) and all other local organizations including transportation, accommodations, food and the performance of rituals. Upon the completion of Hajj, the (MUT) will take his assigned Hajjis to the port of departure where again their documents are processed by the General Agent Office representative and a safe departure is facilitated.

In practicing the various operative features of the system of the present invention, wireless, interactive communication is used extensively. Moreover, educational, guidance and advertising capabilities are implemented which are operative to satisfy the needs of millions of pilgrims who travel in groups of approximately one hundred. These pilgrims and their groups perform the Hajj pilgrimage during the few days of the lunar calendar every year in the Kingdom of Saudi Arabia.

Accordingly, the system includes the basic components comprising an internet based central database and web server (CDW) to hold all data and login accounts for all people participating in the Hajj operation. A mobile, wireless communication device or pilgrim unit or Hajji unit (HU) is distributed to and operated by each pilgrim (H) traveling in the designated groups. A guide unit (GU) also comprising a handheld wireless communication device is maintain by each guide who travels along with an assigned group. A Concerned Government/Public Authority Unit (PU) also comprises the handheld, wireless, mobile communication device is maintained by each of a plurality of public authorities spread over the entire Hajj areas including the cities of Mecca and Medina.

Each of the wireless, mobile communication units or (HU), (GU) and (PU) is loaded with custom developed software which is capable of providing the advertisement and educational information to the pilgrims (H) indicative of what to do and/or say based on the pilgrims (H) current time and location including prayer time and ritual supplications. The units are capable of displaying public broadcast announcements and information advertisements such as the nearest service facilities including food, restroom, medical, public, etc. as needed or required by the pilgrims (H). Each of the (HU), (GU) and (PU), by virtue of an embedded, microcontroller unit or system includes one or more RFID, audio, video, touch screen, GSM and GPS capabilities. Utilizing the GPS sensor and. mapping/tracking capabilities, the pilgrim's location is displayed on his own (HU) along with the location of his designated guide (G) via the corresponding (GU). Each (HU) is responsive to panic conditions and may be activated to report same to corresponding or appropriate (GU) and (PU). Also, each (HU) device is maintained in constant communicative contact with the designated or corresponding guide (G) by virtue of his (GU).

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a composite view in schematic form of at least one preferred embodiment of the system of the present invention.

FIG. 2 is a composite view in schematic form of additional features associated with the embodiment of the system as represented in FIG. 1.

FIG. 3 is a composite view in schematic form of additional features of the system of the present invention as represented in the embodiments of FIGS. 1 and 2.

FIG. 4 is a composite view in schematic form representing yet additional features of the system of the present invention.

FIG. 5 is composite view in schematic form representing yet additional feature of the system of the present invention.

FIG. 6 is a composite view in schematic form representing yet additional features of the system of the present invention.

FIG. 7 is a composite view in schematic form representing yet additional features of the system of the present invention.

Like reference numerals refer to like parts throughout the several views of the drawings.

### DETAILED DESCRIPTION OF THE PREFERRED EMBODIMENT

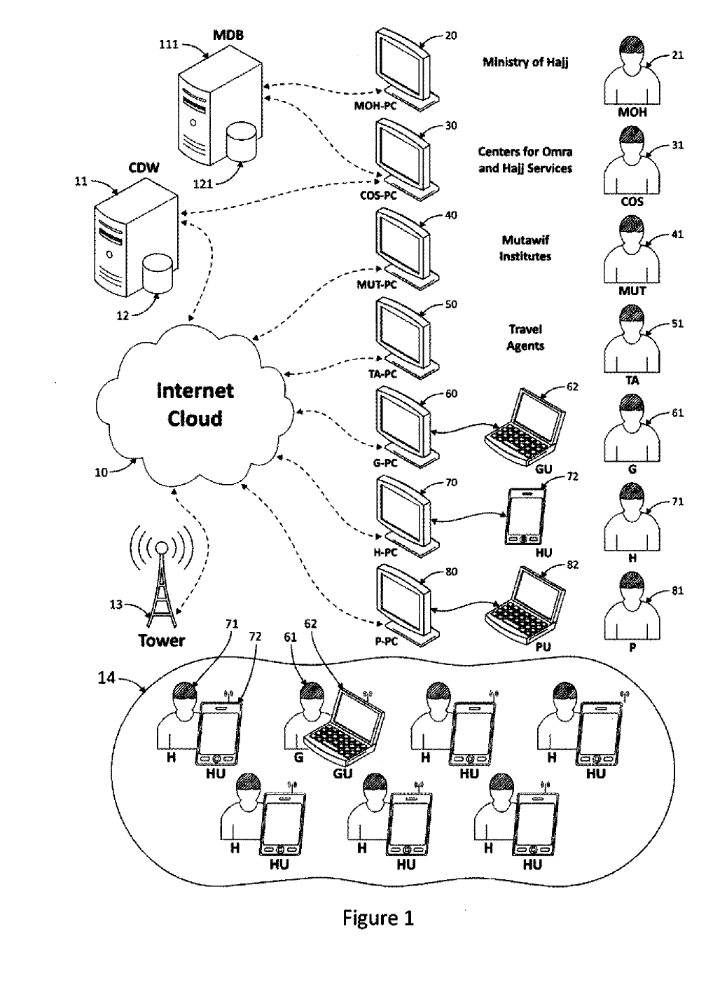

As represented in the accompanying Figures, the present invention is directed to a system for facilitating the participation of a plurality of pilgrims (H) every year to the cities of Mecca and Medina in Saudi Arabia. The annual Hall ritual is performed on an exact, specific number of days on the lunar calendar from month of the Thaul-Hijja, 1 through 15 of each lunar year. As such, FIG. 1 is a schematic representation showing individual system components including a group of pilgrims (H) or Hajjis with their guide (G). A Ministry database (MDB) and the Internet based central database and web server (CDW) are not physically connected but both are accessible by the centers of Omra and Hajj services, (COS). All Hajjis databases are maintained in the CDW and accessed with various levels of control by Mutawif (MUT), Foreign State official Missions/travel agents (TA), guides (G), Hajjis (H) and Concerned Government/Public Authorities (P).

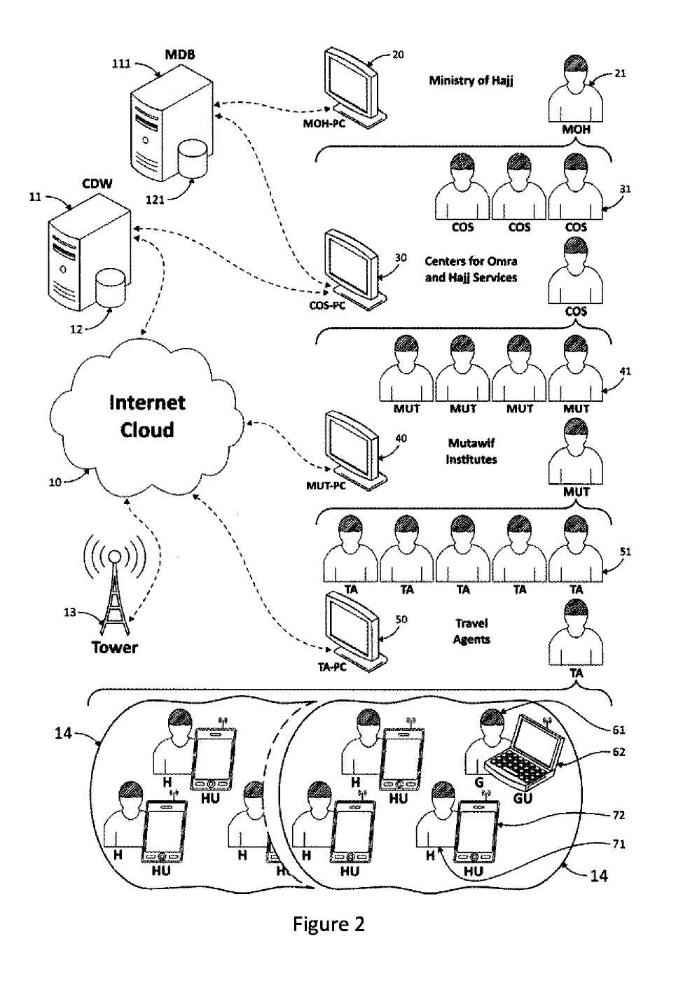

FIG. 2 is a schematic representation representing administration control hierarchy MOH, COS, MUT, within Saudi Arabia. Each MUT handles multiple travel agencies TA with each TA handling various Hajji groups. The COS is responsible for securely copying and updating the entire database from the CDW to the secured MDB. The MOH appoints and controls all COS's, each of which is responsible for a few MUT's assigned to it. Each MUT manages a group of TA's assigned to it and at the time of the Hajj participation, the MUT's provide all local and accommodation services for all pilgrims (H) or Hajjis and all the groups under his TA's.

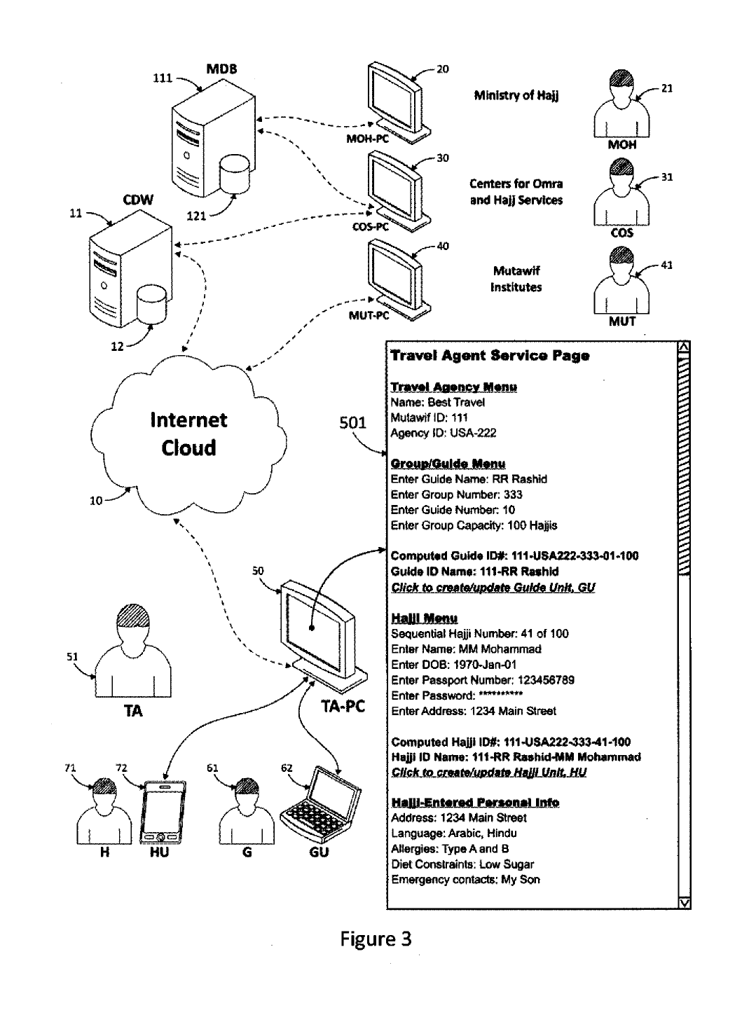

FIG. 3 is representative of travel agencies or TA's using its online service page 501 to set up new Hajji groups, including guide (G), his wireless communication, mobile unit (GU) the Hajjis (H), and their wireless communication mobile devices (HU). The TA's create the online accounts for the G and H and distributes HU's with initial setup and programming already implemented based on their unique border's number and data received from MOH.

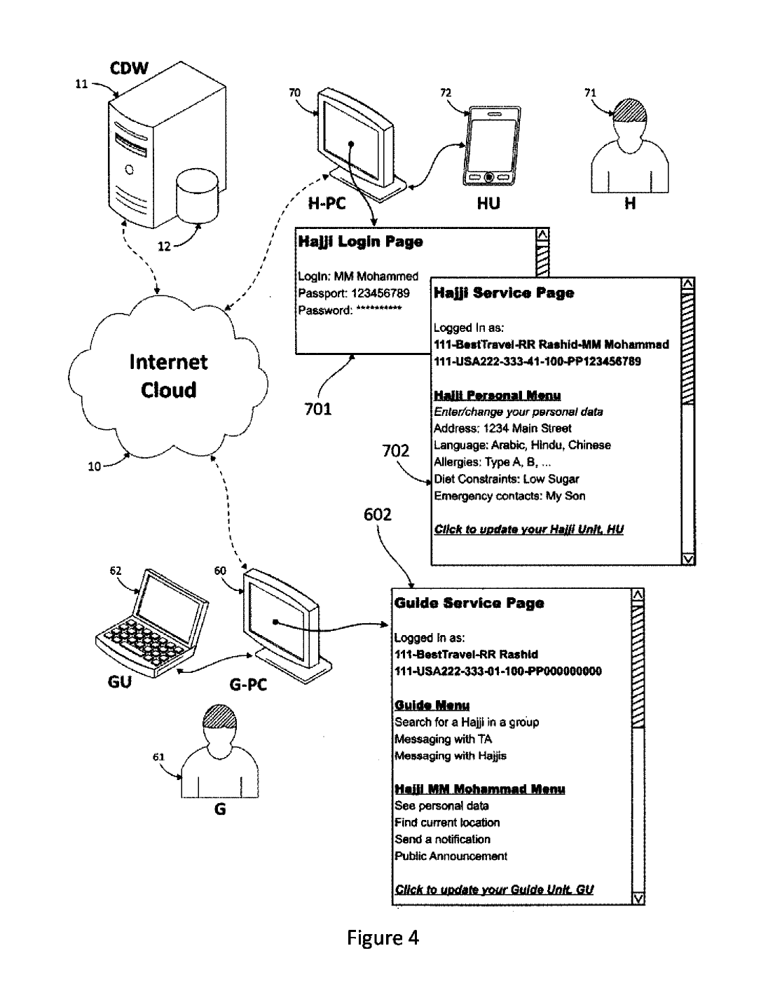

FIG. 4 is representative of the guide G and Hajji H accessing their accounts using their own computers, G-PC and H-PC in order to update their own communication units GU and HU respectively. The G's and the H's enter and modify all their relevant data in advance before the actual Hajj season starts. Such data may include: personal information, Official and passport data, essential health information, etc. By the time the pilgrims H or Hajjis start traveling to Saudi Arabia all data for these millions of Hajji and their exact destination and whereabouts within Saudi Arabia is intact and ready for use. Corresponding Hajj login pages 701; Hajj service pages 702 and Guide service pages 602 are also schematically represented.

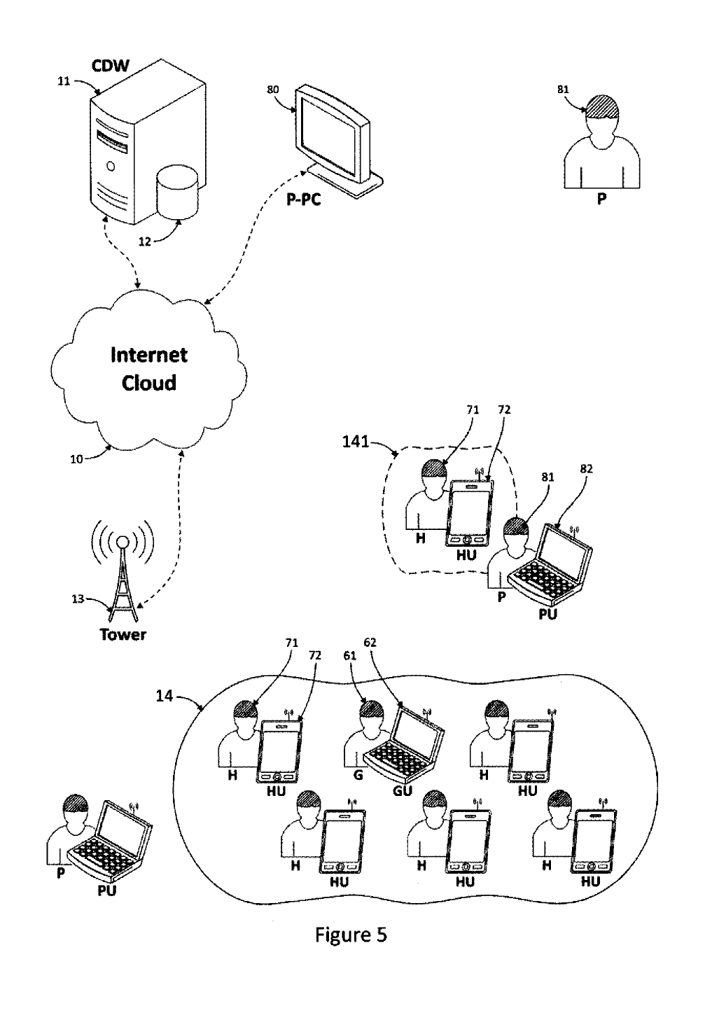

FIG. 5 is representative of a Hajj site in action. More specifically, one representative instance is of a guide G with all his pilgrims H or Hajjis, with one Hajji H lost and recovered by public P. This is representative of an actual group during the Hajj participation. When a Hajji goes astray from his group he reports to the nearest public P with assistance from his communication device or HU.

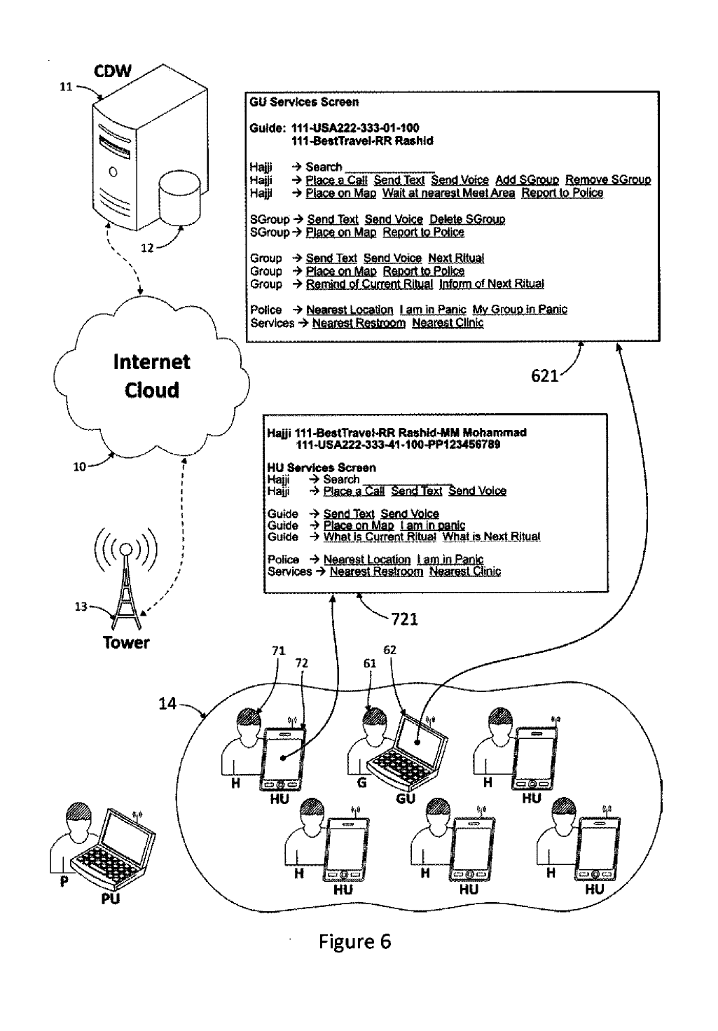

FIG. 6 is further representative of the Hajj in action. More specifically, an instance of an active group is represented, wherein some GU service screens 621 and HU service screens 721 on their respective communication devices GU and HU. This is representative of an actual group during the Hajj performance. The G can broadcast messages and directions to the entire group of H's or an individual H as needed utilizing his GU. Using the available capabilities, the G can also check the location of any H and/or his whereabouts through interactive communication between corresponding GU and HU.

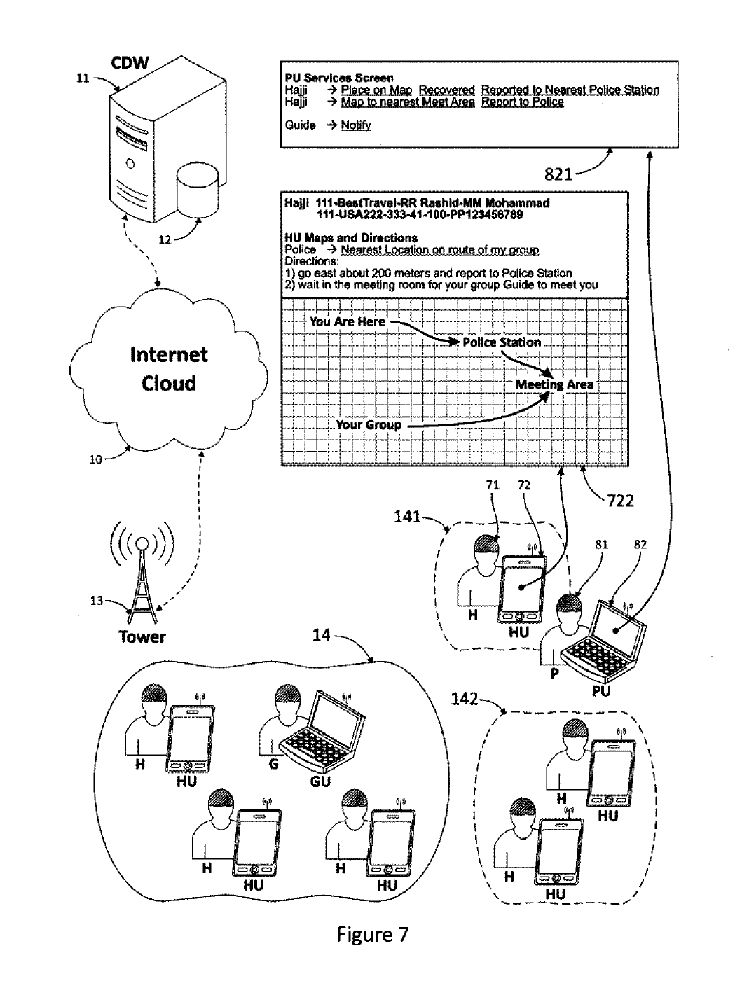

FIG. 7 is also representative of another aspect of the Hajj site in action. More specifically, FIG. 7 represents an instance where the Concerned Government/Public Authorities (P) with three lost pilgrims H or Hajjis, wherein one of them is being directed to join his group through maps and directions on the pilgrim's HU. The lost pilgrim H or Hajj, when realizing he is away from his group activates his panic button on his HU. This serves to automatically notify the communication device GU of his guide G, as well as the nearest communication device or PU of the public authority P. The nearest or other appropriate PU then computes the best way to accomplish the reunion and informs both the HU and the GU accordingly. As also represented in the various Figures, appropriate communication is accomplished over the Internet 10 and or communication towers 13.

Accordingly, the Ministry of Hajj and its administrators, MOH, 21 is the governmental supreme authority of the entire Hajj season and its operation and logistics. The MOH 21 maintains and secures two separate database mainframes, Ministry offline mainframe 111, hosting the archive Ministry database (MDB) 121 and the central shared online mainframe 11 hosting the shared central database and web server, CDW 12. The MOH 21, creates, approves and manages the centers of Omra and Hajj services, COS 31 and certifies their computers COS-PC 30.

The centers of Omra and Hajj Services COS 31 and their computers, COS-PC 30 are further represented. The COS 31 is the ultimate private control centers which are licensed by MOH, and they manage the Hajj season data operations and information management. More specifically, the COS has direct connections to both mainframes 111 and 11 so that as part of their duties, they constantly copy and update data from the active database CDW 12 to the active database MDS 111. In addition, the COS 31 logs in on the CDW 12 to create, appoint and approve the various Mutawif establishments (MUT) 41 accounts who manage and control the entire flow of Hajj operation and logistic from this point on. The COS 31 also creates accounts for the public authority (P) 81. The COS 31 is responsible for the management and distribution of all communication devices, HU 72 and GU 62 for both the pilgrims H and the guides G respectively. These units are distributed to individual Hajjis H and Guides G by their respective travel agents (TA) 51 and in some cases the MUT 41. The COS 31 are also responsible for the management and distribution of the mobile, wireless communication device PU 82 for the Concerned Government/Public Authorities (P) 81.

The Ministry mainframe 111 is physically isolated and secured in Saudi Arabia. The Ministry database, MDB, 21 is the Ministry's master archive and it is not connected to the Internet 10. It is accessed only by the Ministry's administrators MOH 21 via their certified computers MOH-PC 20, and the Ministry appointed centers, COS 31 via their certified computers COS-PC 30.

The central mainframe 11 is physically secured in Saudi Arabia but is connected to the Internet 10. The central database and web server CDW 12 is the Ministry's shared active database and web server for all participants. All participating individuals and agencies MUT 41, TA 51, G 61, H 71 and P 81 login to their accounts on CDW 12 through the Internet 10 via their respective computers. The respective computers are designated as MUT-PC 40, TA-PC 50, G-PC 60, H-PC 70 and P-PC 80. All of the computers have secured access with passwords which entitle then to access different areas of data within the scope of their authorities and responsibilities.

The Mutawif Establishments MUT 41 accounts are local in Saudi Arabia and are created by the COS 31. The MUT 41 via their computers, MUT-PC 40, access the CDW 12 thorough the Internet 10 to create and manage the accounts for the travel agencies, TA 51, who have been assigned to them. Each MUT 41 is made responsible by COS 31 for the Hajji groups and their associate travel agencies TA 51 originating from a certain country or list of countries.

The travel agents or agencies TA are located all over the world and they serve to organize Hajjis in groups 14, which are approximately one hundred pilgrims (H) 71 for each group. The TA's assign a guide, G 61 to each group. The TA 51 via his computer, TA-PC 50, accesses the CDW 12 through the Internet 10 to create and manage the accounts of his various groups of Hajjis 14. For each Hajji group 14, the TA 51 creates an account for the group guide G 61 and every single Hajjis (H) 71 in the group 14. TA 51 collects all vital data from the H's 71 and G's 61 and enters it into the CDW 12. Also the TA's 51 assign accounts and passwords for all H's 71 and G's 61 and create, customize and distribute the communication units or HU's 72 and GU's 62 to the pilgrims H 71 and guides G 61 respectively. Hajjis data is entered throughout the world by appropriate TA's 51 as Hajjis (H) 71 progressively sign up for their Hajj trip.

Prior to the actual Hajji trip the guide (G) 61 uses his own account on his computer G-PC 60 to verify the group of Hajjis 14 and every Hajji (H) 71 associated therewith. The G 61 further acquaints himself with their needs and specific vital information. G 61 connects his computer G-PC 60 to his GU 62 to program and update it. This will ensure that all Hajjis 71 have their accounts completely verified and that their Hajji units (HU) 72 are fully updated with all their vital and personal information.

During the Hajji performance and upon arrival in Saudi Arabia, the G 61 admission to the airport is processed spontaneously by electronically scanning his GU 62 and scanning his fingerprint for authentication and security. The G 61 and/or his assistant uses his GU 62 to guide and communicate with the Hajji group 14, individual pilgrims (H) 71 or the public authority (P) 81. The G 61 periodically checks to verify that all his pilgrims (H) 71 are within his proximity. The G 61 periodically instructs his group 14 or individual (H) 71 of the next move or action.

Each of the GU 62, HU 72 and PU 82 are custom designed wireless, handheld mobile communication devices including at least one or more RFID, audio, video, GSM and GPS capabilities. Each unit stores all data including vital, passport, visa, travel, groups, medical, etc. for fast access and viewing by the public authority P (81) or other authorities as needed. Each provides to the G 61 relevant information at least relating to what to do and/or what to say based on the GU 62 and HU 72 current time and location. For example, prayer times and ritual supplications are provided. Each unit displays various advertisements such as the nearest services facility, food, restroom, medical, public, etc. on a display screen on each of the communication units or GU 62, HU 72 and PU 82. Further, each of the units pulls up all GPS locations from all the assigned or corresponding responsible HU 72 and maps them on a display screen associated with each of the communication units. Further, each unit detects panic conditions from or existing in association with the HU 72 and routes it to the nearest public authority via the PU 82. Each device can display public announcement and impose and assert help and direct messages on the display screen of the HU, 72.

Features and components of the system associated with the Hajji (H) 71 and Hajji computer H-PC 70 includes the following performed prior to the actual Hajj. More specifically, the H 71 uses his own account on his own computer H-PC 70 to verify his own personal and vital data, and acquaint himself with his assigned group 14 and his guide (G) 61. The H 71 picks up his communication device HU 72 from his TA 51 and makes sure that it is programmed with his personal and vital information. The H 71 connects his HU 72 to his computer H-PC 70 to program and update all data associated with the participation in the pilgrimage. During the actual Hall performance and at the arrival in Saudi Arabia the H 71 admission to the airport is processed spontaneously by electronically scanning his HU 72 and scanning his fingerprint for authentication and security. H 71 uses his HU 72 to guide himself and communicate with his group 14, his G 61 and/or the public authority 81. The H 71 periodically checks to verify that he is within the proximity of the G 6i and GU 62 assigned to him. The H 71 constantly follows instructions and directions from his G 61.

The Concerned Government/Public Authorities (P) 81 is located throughout a grid layout in the entire Hajj area within a predetermined or preferred spacing of generally one kilometer. The P 81 is equipped with mobile, wireless communication public units PU 82 as set forth above and/or stationary computers P-PC 80 in stationary locations. Prior to the Hajj trip the P 81 uses a designated account on his computer P-PC 80 to verify his own duties and areas of responsibility and acquaint himself with the overall system. The public authority P 81 connects his PU 82 to the computer P-PC 80 to program and update it.

During the actual Hajj performance the P 81 instantly processes the H 71 and G 61 as they arrive to the airport inside Saudi Arabia. This is done by electronically scanning the HU 72 and/or GU 62 and the fingerprints of H 71 and G 61 for authentication and security. The P 81 uses his PU 82 to guide himself and all those in need from the Hajjis'and guides (G). The P periodically checks any panic conditions within nearby groups 14 responds to any requests from nearby groups through communication with G 62 or H 72. Similar to the GU 62 and HU 72, the PU 82 displays the nearest service facility including food, restroom, medical, public, etc. on the display screen as associated with the PU 82. It pulls all GPS locations from all HU's 72 and GU's 62 from nearby groups 14 and maps them on the associated display screen. It detects panic conditions from any HU 72 or GU 62 and serves to provide assistant by virtue of knowing their location. It can impose and assert help and direction messages on the screen of the HU 72 and/or GU 62. Further, with regard to FIG. 4, 701 designates a Hajji login page, wherein 702 designates a Hajji service page. Also, 602 designates a guide service page as appropriately provided on the G-PC. As further noted throughout the various Figures, an Internet cloud 10 is utilized to establish communication and storage between the above noted units, such as the aforementioned MOH-PC, COS-PC, MUT-PC, TA-PC, G-PC, H-PC and P-PC. In addition 621 designates the GU service screen as provided on the G-PC. Similarly 721 designates the Hajji service screen on the appropriate HU 72 as represented in FIG. 6. FIG. 7 also disclosed the PU service screen 821 and HU maps and directions 722 as designated and displayed on the appropriate devices.

Accordingly, the system of the present invention includes the wireless communication based, educational, safety, guidance, data processing and advertising facilities specifically intended and designed to facilitate the participation by millions of pilgrims throughout a pilgrimage season over a relatively short period of time.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for facilitating participation of a plurality of pilgrims (H) in a seasonal pilgrimage throughout predetermined locations in Saudi Arabia, said system comprising:
a Ministry entity (MOH) defining a control agency for the pilgrimage and including a secure offline database mainframe (MDB) and a shared online mainframe database (CDW),
said (CDW) structured to store data and login accounts for the plurality of pilgrims (H) participating in the pilgrimage,
a plurality of wireless communication pilgrim units (HU) operative by the plurality of participating pilgrims (H),
a plurality of wireless communication guide units (GU) operative by a plurality of pilgrim guides (G) responsible for groups of the plurality of participating pilgrims (H),
a plurality of wireless communication units (PU) operative by Concerned Government/Public Authorities (P) throughout an area where the pilgrimage is conducted, and
said (HU), said (GU) and said (PU) including location and tracking capabilities sufficient to maintain communication between the pilgrims (H), the guides (G) and the public authority (P).

2. A system as recited in claim 1 wherein said (CDW) includes processor facilities networked, to operate as a redundant, distributed database and web server, hosting hierarchal login accounts and shared database management for predetermined participating entities.

3. A system as recited in claim 2 wherein said participating entities include a plurality of accounts from government appointed IT centers (COS), each operated to create and manage a plurality of regulating hosting establishments (MUT); each regulating hosting establishment (MUT) structured to create and manage a plurality of accounts for travel agencies (TA); each of said travel agencies (TA) structured to create and manage a plurality of the group guides (G) and a plurality of accounts for the plurality of pilgrims (H) in each group.

4. A system as recited in claim 2 wherein said (CDW) is structured for shared access by the (COS), (MUT), (TA), (G) and (H) for entry of required vital and personal data; at least some of said data entry accomplished prior to travel of the (H) to the pilgrimage.

5. A system as recited in claim 1 wherein said each of said (HU), (GU) and (PU) include a microcontroller system including at least some of RFID, audio, video, touch screen, GSM and GPS capabilities.

6. A system as recited in claim 5 wherein said (HU) includes software for storage and display of public announcements, useful advertisement and educational information comprising pilgrim (H) behavior based on time and location of the pilgrim (H).

7. A system as recited in claim 6 wherein said educational information further includes prayer times and ritual supplications of the pilgrims (H).

8. A system as recited in claim 6 wherein each of said (HU) is structured to determine and display service facilities including, food, restroom, medical and government/public facilities.

9. A system as recited in claim 6 wherein each of said (HU) is structured to determine corresponding pilgrim (H) and guide (G) locations.

10. A system as recited in claim 6 wherein each of said (HU) is structured to determine, detect and communicate panic conditions to at least one (GU) and (PU) and maintain substantially constant communication with a corresponding (GU).

11. A system as recited in claim 5 wherein each (GU) includes memory capabilities structured to store vital and personal data of the corresponding guide (G).

12. A system as recited in claim 11 wherein said (GU) includes software structured for storage and display of public announcements, useful advertisement and educational information comprising appropriate pilgrim behavior based on time and location of the pilgrim (H).

13. A system as recited in claim 12 wherein said educational information further includes prayer time and ritual supplications of the pilgrims (H).

14. A system as recited in claim 12 wherein each of said (GU) is structured to determine and display and service facilities including food, restroom, medical and government/public facilities.

15. A system as recited in claim 12 wherein each of said (GU) is structured to determine corresponding pilgrim (H) and guide (G) locations.

16. A system as recited in claim 5 wherein each of said (PU) includes memory capabilities structured to store public and vital data including identification and reporting hierarchy, security and medical procedures.

17. A system as recited in claim 16, wherein each of said (PU) includes software structured for storage and display of public announcements, and educational information corresponding to government/public authority (P) and pilgrim (H) behavior indicative of facilitating guides (G) and pilgrims (H).

18. A system as recited in claim 17 wherein said public announcements and educational information further includes hajj groups movement times and official instructions related to ritual supplication of the pilgrim (H).

19. A system as recited in claim 17 wherein each of said (PU) is structured to determine and display service facilities including food, restroom, medical and government/public facilities.

20. A system as recited in claim 17 wherein each of said (PU) is structured to determine corresponding pilgrim (H) and guide (G) locations from nearby groups within a predetermined proximity and maintain substantially continuous communication therewith.

21. A system as recited in claim 17 wherein said (PU) is structured to direct messaging to individual or selected groups of said (HU) and said (GU).

22. A system as recited in claim 1 wherein each of said (HU), (GU), (PU) is structured to recognize and activate any other or said (HU), (GU) and (PU) within a predetermined proximity.
